(19) United States
(12) Patent Application Publication
(10) Pub. No.: US 2023/0323876 A1
(43) Pub. Date: Oct. 12, 2023

(54) Pump Arrangement

(71) Applicant: GKN Sinter Metals Engineering GmbH, Radevormwald (DE)

(72) Inventors: Stefan Tiller, Sankt Augustin (DE); Hong Giang To, Düsseldorf (DE); Tomasz Malogowski, Kielce (PL); Omar Franceschi, Masi Torello (IT); Maurice Andree, Neukirchen-Vluyn (DE)

(21) Appl. No.: 18/022,250

(22) PCT Filed: Aug. 17, 2021
(86) PCT No.: PCT/EP2021/072835

§ 371 Date: Feb. 20, 2023

(30) Foreign Application Priority Data
Aug. 20, 2020 (EP) 20191933.9

(51) Int. Cl. F04C 2/10

(52) U.S. Cl. CPC F04C 2/10; F04C 2240/40

(57) ABSTRACT

A pump arrangement (1) at least comprising a pump (2) having a pressure side (3) and an intake side (4) and a drive unit (5) for the pump (2) which are arranged in a common housing (6), wherein the drive unit (5) is an axial flow electric drive which comprises a stator (7) which is connected to the housing (6) in a rotationally secure manner and a rotor (8) which is arranged so as to be able to be rotated with respect to the housing (6), wherein the rotor (8) is arranged with a first end face (9) opposite the stator (7) in an axial direction (10) and forms an outer conveying means (11) of the pump (2) and has with spacing from the first end face (9) on an inner circumferential face (12) a first conveying profile (13), wherein in a radial direction (14) inside the rotor (8) there is arranged an inner conveying means (15) of the pump (2) which has on an outer circumferential face (16) a second conveying profile (17) which cooperates with the first conveying profile (13) in order to convey a fluid (18).

The invention relates to a pump arrangement at least comprising a pump and a drive unit for the pump which are arranged in a common housing. The drive unit is an axial flow electric drive which comprises a stator which is connected to the housing in a rotationally secure manner and a rotor which is arranged so as to be able be rotated with respect to the housing. The rotor forms an outer conveying means of the pump and has on an inner circumferential face a first conveying profile (for example, a first tooth arrangement or vane of a vane cell pump), wherein in a radial direction inside the rotor there is arranged an inner conveying means of the pump which has on an outer circumferential face a second conveying profile (for example, a second tooth arrangement or a cylindrical outer circumferential face) which cooperates with the first conveying profile in order to convey a fluid and where applicable (in the case of the tooth arrangements) to drive the inner conveying means using the rotor.

In known pump embodiments, a rotor of the pump is arranged on an axle which is guided out of a housing of the pump arrangement.

A pump arrangement is known, for example, from DE 10 2015 207 748 A1. There is described therein a fluid pump which is driven by means of an electric motor. In this instance, a pump rotor of the fluid pump is coupled to the electric motor. The electric motor is an axial flow electric motor the electric motor rotor of which is also the pump rotor or drives a pump rotor. The pump rotor and the electric motor rotor are accommodated in a common housing in which the pump rotor and the electric motor rotor rotate in a disk-like manner in a state integrated as a combination rotor, wherein the common housing has a fluid supply and a fluid discharge to the combination rotor. A pump chamber or fluid conveying chamber is arranged in a closed manner in the common housing and a fluid supply and a fluid discharge to the pump chamber is carried out axially along the rotation axis.

DE 10 2017 113 825 A1 discloses a pump arrangement which comprises at least one pump and a drive unit for the pump which are arranged in a common housing. The drive unit is an axial flow electric drive which comprises a stator which is connected to the housing in a rotationally secure manner and a rotor which is arranged so as to be able to be rotated relative to the housing. The rotor forms an outer conveying means of the pump, wherein in a radial direction within the rotor there is arranged an inner conveying means of the pump which cooperates with the first conveying profile in order to convey a fluid and where applicable (in the case of the tooth arrangements) to drive the inner conveying means using the rotor. The inner conveying means is arranged on a sleeve. A mechanical bearing of the outer conveying means and the rotor is not provided. In order to adjust a leakage-free operation as far as possible, the side walls which surround the rotor are adjusted by means of a pulling means toward a specific spacing with respect to each other.

There is a constant requirement to further simplify such pumps and to configure them in a robust and durable manner for operation. In particular, a compact pump arrangement which can be produced as far as possible in a simple manner and which can be operated substantially without wear is intended to be proposed.

A pump arrangement having the features according to claim 1 contributes to achieving these objectives. Advantageous developments are set out in the dependent claims. The features which are set out individually in the claims can be combined with each other in a technically advantageous manner and can be supplemented by explanatory content from the description and/or details from the Figures, wherein other variants of the invention are set out.

There is proposed a pump arrangement at least comprising a pump having a pressure side and an intake side and a drive unit for the pump which are arranged in a common housing. The drive unit is an axial flow electric drive which comprises (precisely) one stator which is connected to the housing in a rotationally secure manner and (precisely) one rotor which is arranged so as to be able to be rotated with respect to the housing, The rotor is arranged with a first end face opposite the stator or a stator-side housing (that is to say, a housing comprising the stator) in an axial direction and forms an outer conveying means of the pump. The outer conveying means has on an inner circumferential face a first conveying profile. In a radial direction inside the rotor there is arranged an inner conveying means of the pump which has on an outer circumferential face a second conveying profile which cooperates with the first conveying profile in order to convey a fluid. The conveying means are arranged with spacing from the first end face. The inner conveying means is supported on a centering element which is connected to the housing in a rotationally secure manner. At least the rotor and the outer conveying means are configured to be supported exclusively via the fluid conveyed by the pump (in a manner rotatable with respect to other components of the pump arrangement). At least between the first end face and the stator (or the stator-side housing) a first fluid guiding structure is arranged and connected to the pressure side so that during operation of the pump arrangement a gap between the first end face and the stator (or the stator-side housing) can be produced by the fluid.

Electric drives generally comprise a stator and a rotor which are arranged coaxially relative to each other. The rotor is referred to in this instance as the carrier of permanent magnets, whilst the stator has a coil arrangement. In an axial flow motor, the rotor and stator are in particular arranged one behind the other in the axial direction. In this instance, differently magnetized magnets are arranged in the circumferential direction in an alternating manner on the rotor.

The coil arrangement of a stator has cores, for example, which are made of SMC and which are surrounded by current-carrying windings. Each core may be an element which is arranged in order to be magnetized when a current is directed by current-carrying windings around the core. The current-carrying windings may be configured as coils.

SMC is in particular formed from iron powder particles which are electrically insulated from each other. Iron losses in SMC components in an alternating electric field are generally low. In this regard, it therefore appears desirable to use SMC in electric machines at least partially in place of the steel lamination (sheets of steel or electric steel) which are most often used. In order to form a component from SMC, the particles are compressed and hardened. The SMC material is not sintered in this instance. Instead, there is a temperature control to below a melting temperature which is, however, sufficient for the material to permanently keep the provided geometry.

The rotor of the electric drive may have permanent magnets or also magnetically soft elements, for example, in recesses. Using permanent magnets as an electric drive, a permanently excited synchronous or brushless direct-current motor, referred to as a BDLC for short, can thus be formed, whilst, for example, using magnetically soft elements a reluctance motor as an electric motor in an axial, radial or transverse construction type can be provided.

The rotor and stator together form in particular the drive unit of the pump arrangement.

The rotor has on the inner circumferential face a first conveying profile (for example, the first tooth arrangement), via which the inner conveying means cooperates with the second conveying profile which is arranged on the outer circumferential face of the inner conveying means (for example, a second tooth arrangement) in order to convey the fluid. In the case of the conveying profiles being in the form of tooth arrangements, the inner conveying means is driven via the outer conveying means.

An individual drive of the inner conveying means, for example, by means of an axle of the inner conveying means, is not required. The rotor and inner conveying means together form in particular the pump of the pump arrangement which conveys a fluid from one intake side or low-pressure side (fluid inlet) to a pressure side or high-pressure side (fluid outlet).

For such a pump arrangement, for example, gerotor pumps and internal gear pumps (also referred to as crescent pumps) are suitable. Both pump types are characterized by rotors which are parallel but arranged with spacing from each other in the radial direction and which have rotation axes of the tooth arrangement (inner conveying means and outer conveying means). As a result of the tooth arrangements which are in engagement with each other, the driving of one conveying means is carried out by the drive of the other conveying means.

Vane cell pumps and roller cell pumps can be used as a pump arrangement, wherein the outer conveying means comprises the vanes or rollers which can be displaced in a radial direction with respect to the rotation axis as a first conveying profile. The second conveying profile is, for example, formed by means of a cylindrical outer circumferential face of the inner conveying means which cooperates with the vanes or the rollers.

The rotor and the conveying means are in particular arranged in a sliding bearing. During operation of the pump arrangement, there is formed in the sliding bearing, in particular in the bearing which acts with respect to the axial direction, a fluid film which reduces the friction between components which move differently.

The rotor, in particular together with the outer conveying means, is in particular configured without a shaft or is not supported or supported only on a sliding bearing with respect to the radial direction.

During operation of the axial flow electric drive, forces which bring about an attraction of the rotor in the axial direction toward the stator occur in the axial direction. In the embodiment which is proposed in this instance for a compact pump arrangement and which has only one stator, these forces can lead to the rotating rotor contacting the stator or the housing which surrounds the stator. This problem, in pump arrangements in which the rotor is not arranged on a shaft or is arranged in an unsupported state with respect to the radial direction, is further exacerbated since the rotor without any shaft can more readily tilt during operation. In the case of an only slightly skewed arrangement of the rotor (the end faces of the rotor cannot generally actually be produced perpendicularly to the rotation axis), only local contact between the rotor and housing or stator can occur. In this instance, as a result of the rotor, a material-removing action on the housing or the stator can be carried out, by means of which permanent damage to the pump arrangement occurs and the service-life can be significantly limited.

In the present pump arrangement, a tilting of the rotor is prevented or reduced inter alia in particular as a result of the largest possible diameters of the faces of the rotor which act as bearings with respect to the axial direction.

It is proposed in this instance that a first fluid guiding structure is arranged between the first end face of the rotor and the stator or the stator-side housing and is connected to the pressure side so that during operation of the pump arrangement a gap can be produced between the first end face and the stator or the stator-side housing by the fluid. The pressure adjusted by the pump arrangement at the pressure side is in this instance used to adjust and maintain the spacing in the axial direction between the first end face and the stator or the housing.

The spacing between the electromagnetic rotor component (the magnet) and the electromagnetic stator component is in particular approximately 0.5 mm and is in particular not notably influenced by the fluid. The spacing which is adjusted during operation of the pump arrangement between the rotor and stator or stator-side housing as a result of the fluid and which forms the gap is in particular exclusively provided to prevent friction between the components and consequently wear. The gap, that is to say, the spacing which is formed by the fluid, is in particular significantly smaller than the spacing of the electromagnetic components of the rotor and stator.

The first fluid guiding structure comprises in particular a channel structure which is formed at least on one of the surfaces which form the gap. These surfaces are at least formed by the first end face of the rotor and by the wall of the stator or the housing opposite the first end face. In particular, there is particularly no gap with a constant gap dimension, but instead the gap dimension varies locally as a result of the channel structure which is configured on at least one surface. Via the channel structure, the fluid can in particular be conveyed at least in the radial direction through the gap (and beyond the gap). In particular, at least one flow channel, along which the fluid is conveyed through the gap (and beyond the gap), is provided in this case for the fluid.

The fluid should in particular be substantially conveyed into the gap in order to reduce the friction between components at that location. The conveying of the fluid beyond the gap is in particular only a technically necessary measure in order to convey the fluid into the gap. In particular, the fluid should not be conveyed selectively beyond the gap, but instead this internal leakage is intended to be kept as low as possible.

Particularly along the extent of the first fluid guiding structure or along the channel structure in the gap, a substantially constant pressure of the fluid is provided. There are thus in particular along the first fluid guiding structure or along a flow channel of the channel structure no throttle portions which bring about a stepped or continuous pressure drop. In this instance, a throttled pressure may well be present between different flow channels of a channel structure.

In particular, the pump arrangement is configured in such a manner that, as a result of the pressure of the fluid produced during operation of the pump arrangement at the pressure side, the axial forces acting between the stator and rotor can (just) be compensated for. Where applicable, the pressure of the fluid applied in the gap between the rotor and stator can be adjusted by means of a (controllable or constant) throttle.

In particular, the rotor extends between a first end face facing the stator and a second end face which is arranged opposite in the axial direction over a first width, wherein the first conveying profile and the second conveying profile each extend over a smaller second width. The conveying profiles have in particular the same width so that the end faces of the inner conveying means and outer conveying means can be arranged in alignment with each other in the radial direction.

In particular, the second conveying profile cooperates with the first conveying profile in order to drive the inner conveying means, wherein the inner conveying means is rotatably supported on the centering element. In this instance, the inner conveying means is also supported exclusively by means of the fluid conveyed by the pump.

In particular, the gap between the rotor and stator is formed exclusively by the first end face of the rotor and not by the outer or inner conveying means. The conveying means are arranged in the axial direction with spacing from the first end face. The conveying means extend in particular as far as the second end face of the rotor. The rotor is thus in particular constructed in a disk-like manner. The first fluid guiding structure can consequently be arranged on a large face so that with the fluid over the large face significant axial forces which are produced during operation of the electric drive can be compensated for.

In particular, the housing has at a second end face, which is arranged opposite the first end face, of the rotor a pressure line which is connected to the pressure side of the pump arrangement. In particular, the first fluid guiding structure is connected to the pressure line (exclusively) via the centering element and/or via the conveying profiles.

In particular, the fluid is conveyed from the pressure line (exclusively) via the centering element in the direction toward the first fluid guiding structure.

In particular, the rotor has (only) one through-opening which extends at least in the axial direction and via which the fluid can be conveyed from the pressure line or from the pressure side toward the first fluid guiding structure. In particular, the through-opening has a greatest opening cross section which has a maximum of two (2) %, preferably a maximum of one (1) %, in a particularly preferred manner a maximum of 0.5%, of the surface-area of the first end face of the rotor.

In particular, the first fluid guiding structure is connected to the pressure line (exclusively) by means of the at least one through-opening.

In particular, the inner conveying means is rotatably supported on a first outer circumferential face of the centering element, wherein a second fluid guiding structure for connecting the pressure line to the first fluid guiding structure is formed at least partially on the first outer circumferential face. In particular, a hydrodynamic or hydrostatic bearing of the inner conveying means on the centering element can thus be produced.

The second fluid guiding structure may in particular be constructed in the manner of the first fluid guiding structure, wherein the second fluid guiding structure is provided to produce a gap which extends parallel with the rotation axis between the centering element and inner conveying means.

In particular, the housing has at a second end face, which is arranged opposite the first end face, of the rotor an intake line which is connected to the intake side. A transmission, which can be referred to as a leakage, of the fluid out of the first fluid guiding structure is carried out in particular via a second outer circumferential face of the rotor in the direction toward the intake line. This leakage serves in particular to lubricate the mutually opposing surfaces of the rotor and housing.

With the pump arrangement, a fluid can be conveyed through the conveying profiles from the intake line toward the pressure line. The quantity of fluid used to lubricate and support the components and to ensure the gap may at least partially (as a leakage) flow (back) from the pressure side via the gap in the direction toward the intake side.

In particular, the fluid is conveyed from the pressure line via the centering element and via the second fluid guiding structure and via the through-opening in the direction toward the first end face of the rotor. In particular, the fluid (in this instance, however, in particular only as a leakage) is conveyed along the gap between the first end face and stator and at least in the radial direction beyond the gap in an outward direction. The fluid (then) flows via the second outer circumferential face of the rotor (that is to say, between the housing and rotor) toward the second end face and to the intake side which is arranged at that location.

In particular, the rotor and the outer conveying means are configured in two pieces, preferably produced in two pieces, that is to say, separately from each other. In particular, the rotor and the outer conveying means are connected to each other in a rotationally secure manner. The connection may, for example, be produced by means of connection elements, for example, by means of dowel pins, screw connections, etcetera.

In particular, at least components which rotate during operation of the pump arrangement (rotor, outer conveying means, inner conveying means) of the pump arrangement are arranged in a contact-free manner with respect to fixed components (housing, stator, centering element) of the pump arrangement. In particular, at least during operation of the pump arrangement there is no mechanical contact between rotating components of the pump arrangement and fixed components of the pump arrangement.

In particular, all rotating components run in fluid. In particular, as a result of the fluid, contact between rotating components of the pump arrangement and fixed components of the pump arrangement is prevented or a contact-free arrangement is ensured.

In particular, tolerances of the components which are intended to be otherwise produced in a highly precise manner can be relaxed so that costs for the production of the pump arrangement can be reduced. The perpendicularity which is otherwise required between the rotation axis and first end face is in this instance in particular intended to be configured with a lower level of precision since the gap between the rotor and housing or stator is ensured by means of the fluid.

In particular, in this pump arrangement, the parallel nature of the end faces of the rotor are the remaining significant tolerances which are intended to be configured in a very precise manner. They may be produced in a much more cost-effective manner (for example, by means of dual disk grinding).

In particular, at least the rotor is produced using powder metallurgy. In particular, at least the stator is produced using powder metallurgy. In particular, the rotor is also produced using sintering technology.

Preferably, the pump
is a gerotor pump or an internal gear pump (also referred to as a crescent pump) and the first conveying profile is a first tooth arrangement and the second conveying profile is a second tooth arrangement, wherein the tooth arrangements have mutually different numbers of teeth; or
is a vane cell pump or a roller cell pump;
   wherein a first rotation axis of the rotor and a second rotation axis of the inner conveying means are arranged parallel with each other and spaced apart from each other in the radial direction.

In particular, the pump arrangement has exclusively static seals, that is to say, seals which are arranged only between components which are arranged in a rotationally secure manner. Consequently, a secure and permanent sealing can be ensured by means of exclusively static seals.

The pump arrangement has in particular the following operating parameters:
nominal power consumption in Watt:
   from 0 to 2,000; preferably from 50 to 200;
nominal maximum operating pressure in bar:
   from 0 to 100; preferably from 4 to 12;
volume output in liters per minute:
   from 0 to 50; preferably, from 3 to 12;
speed of the rotor in revolutions per minute:
   from 0 to 7,000; preferably, from 1,000 to 4,000.

The gap between the first end face of the rotor (particularly not in the region of the magnets) and the housing or the stator, that is to say, in particular the gap which forms the plain bearing or the 10 gap which is formed by the first fluid guiding structure, is during operation of the pump arrangement in particular at least 0.003 millimeter, preferably a maximum of 0.1 millimeter, in a particularly preferred manner a maximum of 0.05 millimeter or even a maximum of 0.01 millimeter.

In particular, the gap between the magnets and the housing or the stator is at least 0.2 millimeter, preferably at least 0.3 millimeter. Preferably, the gap in this region is a maximum of 1.5 mm, in a particularly preferred manner a maximum of 1.0 mm, in particular from 0.3 to 0.7 mm.

The use of indefinite articles (“a/an”), in particular in the claims and the description which reproduces them, is intended to be understood per se and not as a numeral. Terms or components which are introduced in accordance therewith are consequently intended to be understood so that they are present at least once but in particular may also be present multiple times.

By way of precaution, it should be noted that the numerals used here (“first”, “second”, etc.) are used primarily (only) to distinguish a plurality of identical objects, variables or processes, that is to say, in particular they do not necessarily predetermine any dependency and/or sequence of these objects, variables or processes with respect to each other. Should a dependency and/or sequence be required, this is explicitly set out in this instance or it is evident to the person skilled in the art when studying the configuration which is specifically described. If a component may appear several times (“at least one”), the description relating to one of these components may apply equally to all or some of the plurality of these components, but this is not necessarily the case.

The invention and the technical environment are explained in greater detail below with reference to the appended Figures. It should be noted that the invention is not intended to be limited by the embodiments which are set out. In particular, unless otherwise explicitly set out, it is also possible to extract partial aspects of the content explained in the Figures and to combine them with other components and findings from the present description. In particular, it should be noted that the Figures and in particular the size relationships illustrated are only schematic. In the drawings:

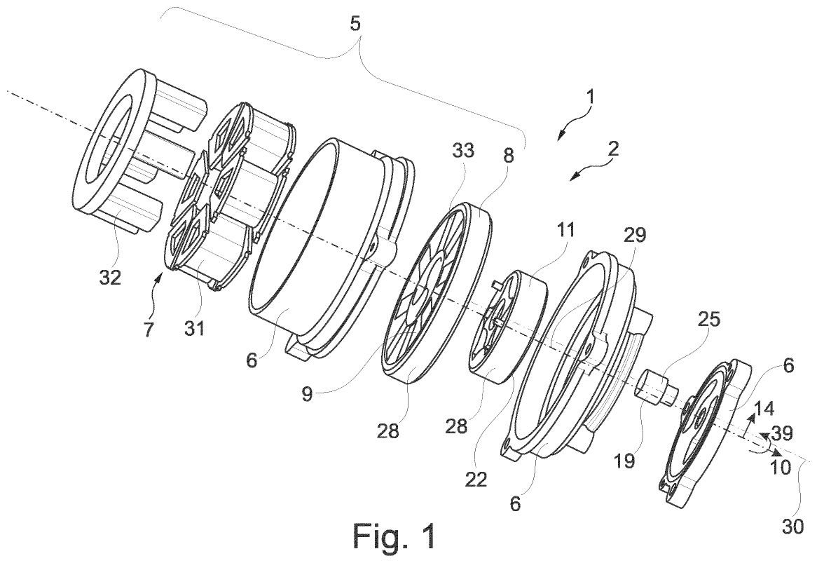

FIG. 1: shows a pump arrangement as an exploded perspective illustration;

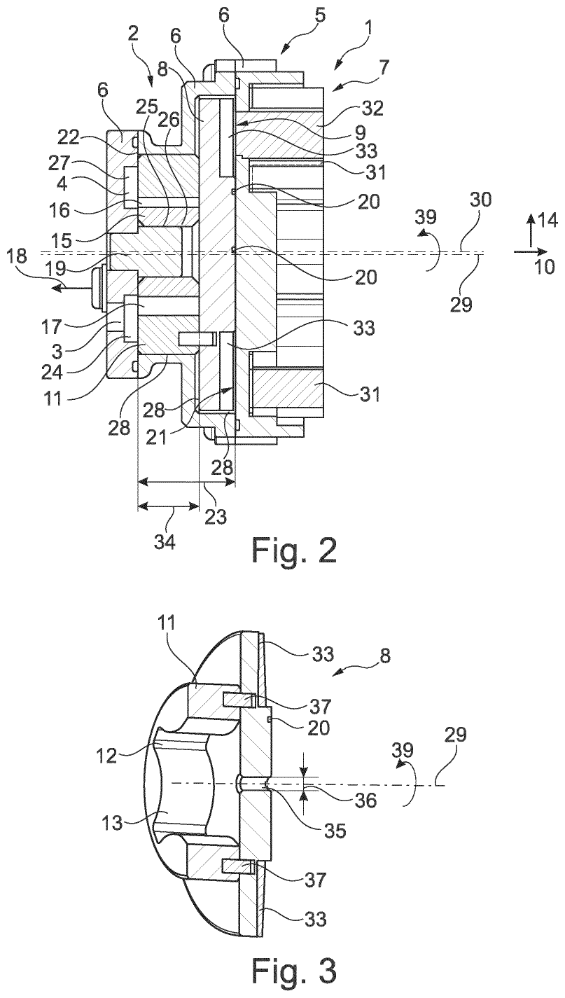

FIG. 2: shows a side view of the pump arrangement according to FIG. 1 in cross section; and

FIG. 3: shows the rotor of the pump arrangement as a perspective view;

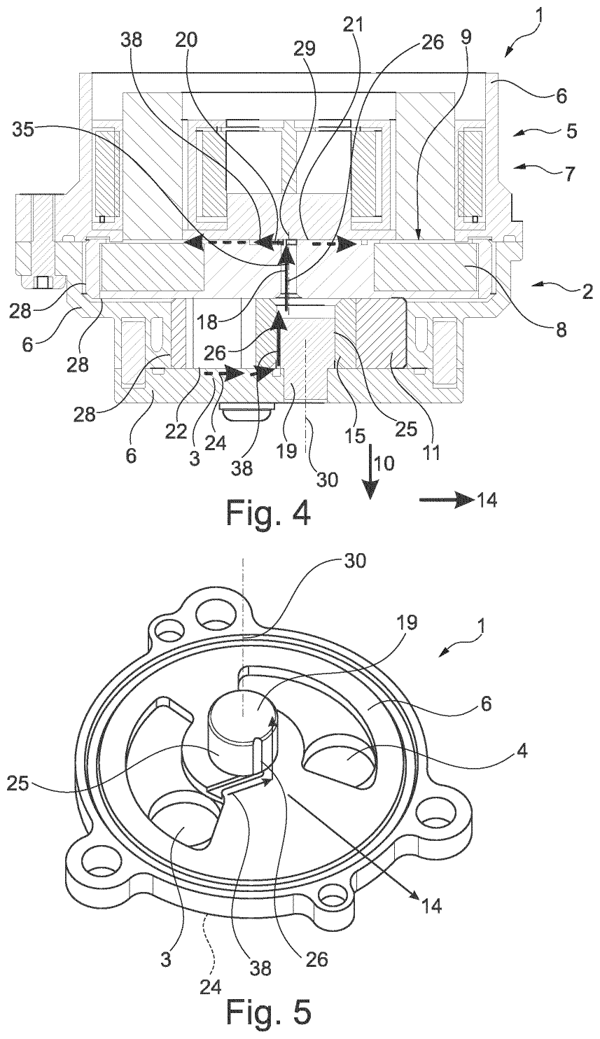

FIG. 4: shows the pump arrangement as a side view in section with the flow path from the pressure side to the first end face;

FIG. 5: shows a portion of the pump arrangement as a perspective view with a portion of the flow path according to FIG. 4;

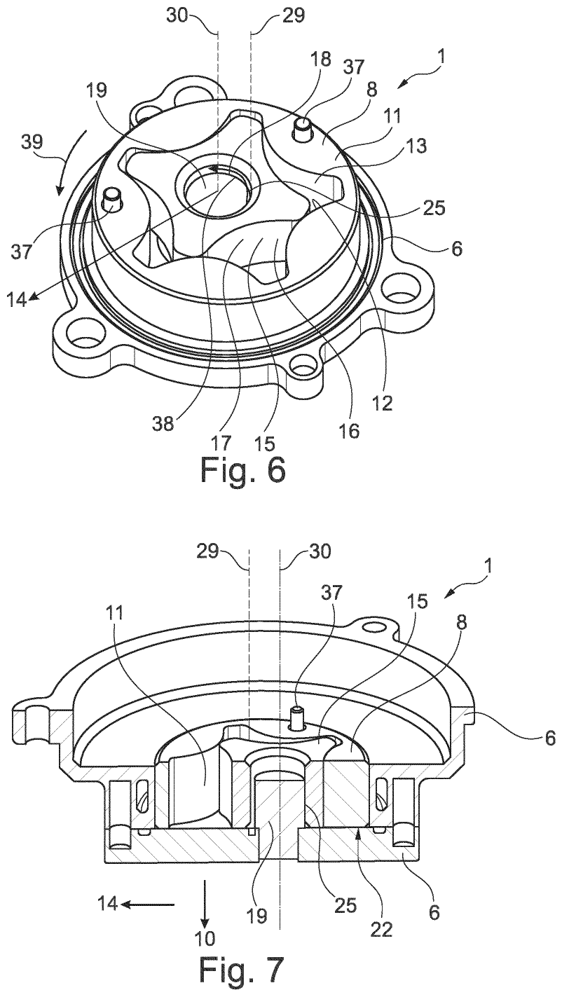

FIG. 6: shows a portion of the pump arrangement as a perspective view with another portion of the flow path, according to FIG. 4, which adjoins the flow path according to FIG. 5;

FIG. 7: shows a portion of the pump arrangement according to FIG. 4 as a perspective view;

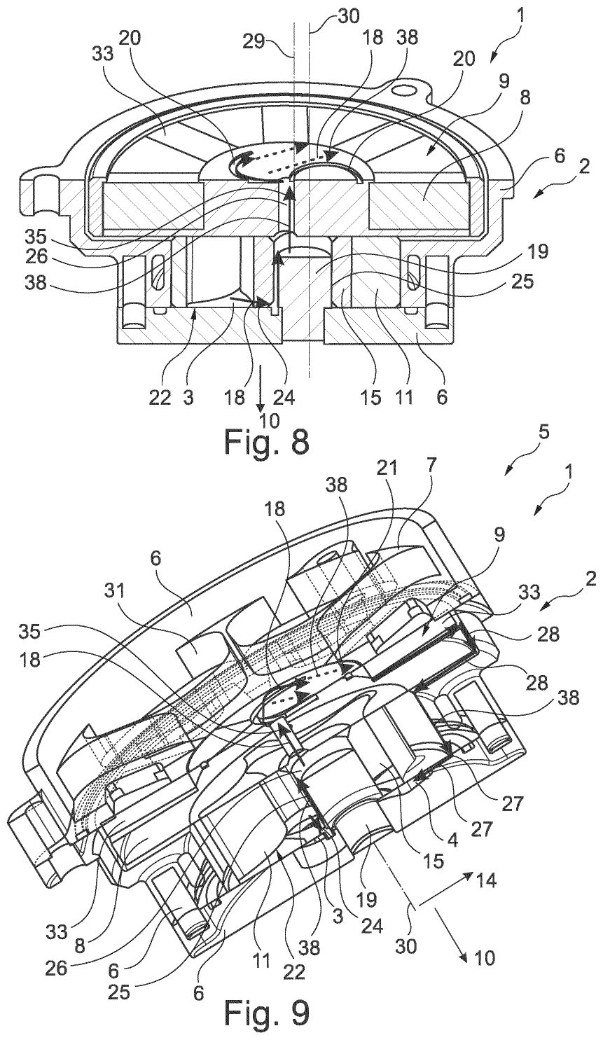

FIG. 8: shows a portion of the pump arrangement as a perspective view with the portion of the flow path according to FIG. 4 and another portion of the flow path which adjoins the flow path according to FIG. 6; and

FIG. 9: shows the pump arrangement according to FIG. 2 as a perspective sectioned view.

FIG. 1 shows a pump arrangement 1 as an exploded perspective view. FIG. 2 shows a pump arrangement 1 as a sectioned side view. FIG. 3 shows the rotor 8 of the pump arrangement 1 as a perspective view. FIG. 4 shows the pump arrangement 1 as a sectioned side view with the flow path 34 from the pressure side 3 to the first end face 9. FIG. 5 shows a portion of the pump arrangement 1 as a perspective view with a portion of the flow path 34 according to FIG. 4. FIG. 6 shows a portion of the pump arrangement 1 as a perspective view with another portion of the flow path 34, according to FIG. 4, which adjoins the flow path 34 according to FIG. 5. FIG. 7 shows a portion of the pump arrangement 1 according to FIG. 4 as a perspective view. FIG. 8 shows a portion of the pump arrangement 1 as a perspective view with the portion of the flow path 34 according to FIG. 4 and another portion of the flow path 34 which adjoins the flow path 34 according to FIG. 6. FIG. 9 shows the pump arrangement 1 according to FIG. 2 as a sectioned perspective view. FIGS. 1 to 9 are described together below.

The pump arrangement 1 comprises a pump 2 having a pressure side and an intake side 4 and a drive unit 5 for the pump 2 which are arranged in a common housing 6. The drive unit 5 is an axial flow electric drive which comprises precisely one stator 7 which is connected to the housing 6 in a rotationally secure manner and precisely one rotor 8 which is arranged so as to be able to be rotated relative to the housing 6. The rotor 8 is arranged with a first end face 9 opposite the stator 7 in an axial direction 10 and forms an outer conveying means 11 of the pump 2. The outer conveying means 11 has on an inner circumferential face 12 a first conveying profile 13. In a radial direction 14 inside the rotor 8 there is arranged an inner conveying means 15 of the pump 2 which has on an outer circumferential face 16 a second conveying profile 17 which cooperates with the first conveying profile 13 in order to convey a fluid 18. The conveying means 11, 15 are arranged with spacing from the first end face 9. The inner conveying means 15 is supported on a centering element 19 which is connected to the housing 6 in a rotationally secure manner. The rotor 8 and the outer conveying means 11 are rotatably supported with respect to other components of the pump arrangement 1 exclusively by means of the fluid 18 which is conveyed by the pump 2. Between the first end face 9 and the stator 7 a first fluid guiding structure 20 is arranged and connected to the pressure side 3 so that during operation of the electric drive a gap 21 can be produced between the first end face 9 and the stator 7 by the fluid 18.

The coil arrangement of the stator 7 has cores 32, for example, which are made of SMC and which are surrounded by current-carrying windings 21.

The rotor 8 of the electric drive has magnets 33. Cores 32 and windings 31 are arranged with spacing with respect to the magnets 33 by means of the gap 21.

The rotor 8 has on the inner circumferential face 12 a first conveying profile 13 (in this instance, a first tooth arrangement) via which the inner conveying means 15 cooperates with the second conveying profile 17 (in this instance, a second tooth arrangement) arranged on the outer circumferential face 16 of the inner conveying means 15 in order to convey the fluid 18. When the conveying profiles 13, 17 are in the form of tooth arrangements, the inner conveying means 15 is driven by the outer conveying means 11. A first rotation axis 29 of the rotor 8 (and the outer conveying means 11) and a second rotation axis 30 of the inner conveying means 15 are arranged parallel with each other and spaced apart from each other in the radial direction 14. The pump 2 is in the form of a gerotor pump.

During operation of the axial flow electric drive, forces which bring about an attraction of the rotor 8 in the axial direction 10 toward the stator 7 occur in the axial direction 10. As a result of the first fluid guiding structure 20 which is arranged between the first end face 9 and the stator 7 and which is connected to the pressure side 3, during operation of the electric drive a gap 21 is adjusted between the first end face 9 and the stator 7 by the fluid 18. The pressure of the fluid 18 adjusted by the pump arrangement 1 on the pressure side 3 is used in this instance to adjust and maintain the spacing in the axial direction 10 between the first end face 9 and the stator 7 or the housing 6.

The rotor 8 extends between a first end face 9 facing the stator 7 and a second end face 22 which is arranged opposite in the axial direction 10 via a first width 23, wherein the first conveying profile 13 and the second conveying profile 17 extend in each case over a smaller second width 34.

The gap 21 between the rotor 8 and stator 7 is formed exclusively by the first end face 9 of the rotor 8 and not by the conveying means 11, 15. The conveying means 11, 15 are arranged in the axial direction 10 with spacing from the first end face 9. The conveying means 11, 15 extend as far as the second end face 22 of the rotor 8. The rotor 8 is constructed in a disk-like manner.

The rotor 8 has a through-opening 35 which extends in the axial direction 10 and via which fluid 18 can be conveyed from the pressure line 24 or from the pressure side 3 in the direction toward the first fluid guiding structure 20 along the flow path 38 (see FIGS. 4, 8, 9). The through-opening 35 has a greatest opening cross section 36.

The housing 6 has at a second end face 22, which is arranged opposite the first end face 9, of the rotor 8 a pressure line 24 which is connected to the pressure side 3, wherein the first fluid guiding structure 20 is connected to the pressure line 24 via the through-opening 35 and the centering element 19 and/or via the conveying profiles 13, 17.

The fluid 18 is conveyed from the pressure line 24 via the centering element 19 and the through-opening 35 toward the first fluid guiding structure 20 along the flow path 38 (see FIGS. 4, 8, 9).

The inner conveying means 15 is rotatably supported on a first outer circumferential face 25 of the centering element 19, wherein a second fluid guiding structure 26 is constructed to connect the pressure line 24 to the first fluid guiding structure 20 on the first outer circumferential face (see FIGS. 4 to 6 and 8, 9).

The housing 6 has at a second end face 22, which is arranged opposite the first end face 9, of the rotor 8 an intake line 27 which is connected to the intake side 4, wherein leakage of the fluid from the first fluid guiding structure 20 is carried out via a second outer circumferential face 28 of the rotor 8 in the direction toward the intake line 27 (see FIG. 9).

The fluid 18 is conveyed from the pressure line 24 via the centering element 19 and via the second fluid guiding structure 26 and via the through-opening 35 and where applicable via the conveying profiles 13, 17 in the direction toward the first end face 9 of the rotor 8 (see FIGS. 4, 8 and 9). The fluid 18 is then conveyed along the gap 21 between a first end face 9 and stator 7 and at least in the radial direction 14 through the gap 21 and as a leakage beyond the gap 21 toward the outer side (see FIGS. 4, 8, 9). The fluid 18 then flows as a leakage via the second outer circumferential face 28 of the rotor 8 (that is to say, between the housing 6 and rotor 8) toward the second end face 22 and to the intake side 4 which is arranged at that location (see FIGS. 4 and 9).

The rotor 8 and the outer conveying means 11 are constructed in two pieces, that is to say, produced in two pieces or separately from each other. The rotor 8 (or the disk-like portion of the rotor 8) and the outer conveying means 11 are connected to each other in a rotationally secure manner in order to form the rotor 8. The connection is produced by means of connection elements 37, in this instance by means of dowel pins.

At least during operation of the pump arrangement 1, rotating components (rotor 8, outer conveying means 11, inner conveying means 15) of the pump arrangement 1 are arranged in a contact-free manner with respect to fixed components (housing 6, stator 7, centering element 19) of the pump arrangement 1. All the rotating components are consequently moved in the fluid 18. As a result of the fluid 18, contact between rotating components of the pump arrangement 1 and fixed components of the pump arrangement 1 is prevented or a contact-free arrangement is ensured.

### LIST OF REFERENCE NUMERALS

1 Pump arrangement
2 Pump
3 Pressure side
4 Intake side
5 Drive unit
6 Housing
7 Stator
8 Rotor
9 First end face
10 Axial direction
11 Outer conveying means
12 Inner circumferential face
13 First conveying profile
14 Radial direction
15 Inner conveying means
16 Outer circumferential face
17 Second conveying profile
18 Fluid
19 Centering element
20 First fluid guiding structure
21 Gap
22 Second end face
23 First width
24 Pressure line
25 First outer circumferential face
26 Second fluid guiding structure
27 Intake line
28 Second outer circumferential face
29 First rotation axis
30 Second rotation axis
31 Winding
32 Core
33 Magnet
34 Second width
35 Through-opening
36 Opening cross section
37 Connection means
38 Flow path
39 Circumferential direction

1. A pump arrangement comprising a pump having a pressure side and an intake side and a drive unit for the pump which are arranged in a common housing, wherein the drive unit is an axial flow electric drive which comprises a stator which is connected to the housing in a rotationally secure manner and a rotor which is arranged so as to be able to be rotated with respect to the housing, wherein the rotor is arranged with a first end face opposite the stator in an axial direction and forms an outer conveying means of the pump and has on an inner circumferential face a first conveying profile, wherein in a radial direction inside the rotor there is arranged an inner conveying means of the pump which has on an outer circumferential face a second conveying profile which cooperates with the first conveying profile in order to convey a fluid; wherein the conveying means are arranged with spacing from the first end face; wherein the inner conveying means is supported on a centering element which is connected to the housing in a rotationally secure manner; wherein at least the rotor and the outer conveying means are configured to be supported exclusively via the fluid conveyed by the pump; wherein at least between the first end face and the stator a first fluid guiding structure is arranged and connected to the pressure side so that during operation of the electric drive a gap between the first end face and the stator is producible by the fluid.

2. The pump arrangement as claimed in claim 1, wherein the rotor extends between the first end face facing the stator and a second end face which is arranged opposite in the axial direction over a first width, wherein the first conveying profile and the second conveying profile each extend over a smaller second width, wherein the conveying profiles are arranged in the axial direction with spacing from the first end face.

3. The pump arrangement as claimed in claim 1, wherein the second conveying profile cooperates with the first conveying profile in order to drive the inner conveying means, wherein the inner conveying means is rotatably supported on the centering element; wherein the inner conveying means is also supported exclusively by the fluid conveyed by the pump.

4. The pump arrangement as claimed in claim 1, wherein the housing has at a second end face, which is arranged opposite the first end face, of the rotor a pressure line which is connected to the pressure side, wherein the first fluid guiding structure is connected to the pressure line via the centering element.

5. The pump arrangement as claimed in claim 4, wherein the inner conveying means is rotatably supported on a first outer circumferential face of the centering element, wherein a second fluid guiding structure for connecting the pressure line to the first fluid guiding structure is formed at least partially on the first outer circumferential face.

6. The pump arrangement as claimed in claim 1, wherein the housing has at a second end face, which is arranged opposite the first end face, of the rotor an intake line which is connected to the intake side, wherein a leakage of the fluid from the first fluid guiding structure s carried out via a second outer circumferential face of the rotor in the direction toward the intake line.

7. The pump arrangement as claimed in claim 1, wherein the rotor and the outer conveying means are configured in two pieces but are connected to each other in a rotationally secure manner.

8. The pump arrangement as claimed in claim 1, wherein at least components, which rotate during operation of the pump arrangement, of the pump arrangement are arranged in a contact-free manner with respect to fixed components of the pump arrangement.

9. The pump arrangement as claimed in claim 1, wherein the rotor has a through-opening which extends at least in the axial direction and via which the fluid is conveyable from the pressure side toward the first fluid guiding structure, wherein the through-opening has a largest opening cross section which has a maximum of two percent of the surface-area of the first end face of the rotor.

10. The pump arrangement as claimed in claim 1, wherein the pump
is a gerotor pump or an internal gear pump and the first conveying profile is a first tooth arrangement and the second conveying profile is a second tooth arrangement, wherein the tooth arrangements have mutually different numbers of teeth; or
is a vane cell pump or a roller cell pump;
and wherein a first rotation axis of the rotor and a second rotation axis of the inner conveying means are arranged parallel with each other and spaced apart from each other in the radial direction.
